(19) United States
(12) Patent Application Publication
(10) Pub. No.: US 2018/0016412 A1
(43) Pub. Date: Jan. 18, 2018

(54) FLAME RETARDANT COMBINATIONS FOR POLYESTERS AND FLAME RETARDED POLYESTER MOULDING COMPOSITIONS THEREFROM

(71) Applicants: CLARIANT INTERNATIONAL LTD., Muttenz (CH); FRX POLYMERS, INC., Chelmsford, MA (US)

(72) Inventors: Wolfgang WANZKE, Augsburg (DE); Sebastian HOEROLD, Diedorf (DE); Marc-Andre LEBEL, Boxborough, MA (US); Karl Dieter FREITAG, Krefeld (DE)

(21) Appl. No.: 15/715,735

(22) Filed: Sep. 26, 2017

Related U.S. Application Data
(63) Continuation of application No. 12/920,917, filed on Sep. 3, 2010, now abandoned.
(60) Provisional application No. 61/143,246, filed on Jan. 8, 2009.

(51) Int. Cl. C08K 5/00; C08K 5/53; C08K 5/3492

(52) U.S. Cl. CPC C08K 5/0066; C08K 5/34924; C08K 5/53

(57) ABSTRACT

Disclosed are new compositions consisting of mixtures of flame retardants for thermoplastic polyesters based on a phosphinate salt, phosphonate oligomers, polymers or copolymers and a melamine derivative. The compositions exhibit an excellent combination of processing characteristics, thermal and mechanical properties, and are flame retardant. Further disclosed are articles of manufacture produced from these materials, such as fibers, films, coated substrates, moldings, foams, fiber-reinforced articles, or any combination thereof.

The invention relates to mixtures of flame retardants for thermoplastic polyesters based on a phosphinate salt and phosphonate oligomers, polymers and/or copolymers and a melamine derivative.

The salts of phosphinic acids (phosphinates) have proven to be effective flame-retardant additives for thermoplastic polymers (DE-A-2 252 258 and DE-A-2 447 727). Calcium phosphinates and aluminum phosphinates have been described as particularly effective in polyesters, giving less impairment of the properties of the polymer molding composition materials than, for example, the alkali metal salts (EP-A-0 699 708).

Synergistic combinations of phosphinates with various nitrogen-containing compounds have also been found and are more effective as flame retardants than the phosphinates alone in a large number of polymers (WO 97/39053, DE-A-1 97 34 437, DE-A-1 97 37 727, and U.S. Pat. No. 6,255,371 B1).

Whereas certain phosphinates are efficient flame retardants with regard to fire tests in which self extinguishing properties are required, like in UL 94 V-0, the performance in tests where ignitability is a criterion, like the glow wire test according to IEC 60695-2-13, is not always sufficient. For the design of electrical appliances a GWIT (glow wire ignition temperature) of 775° C. is desirable for reinforced polyester materials.

When the phosphinates are used as neat flame retardants or combined with nitrogen synergists in polyesters, the result is generally a certain degree of polymer degradation during processing, which has an adverse effect on mechanical properties.

Surprisingly, it has now been found that the addition of some phosphonate oligomers, polymers or copolymers further improve the flame retardant action of phosphinates, improve the GWIT while simultaneously inhibit or suppress polyester degradation caused by the phosphinates.

The invention therefore provides a flame retardant mixture for thermoplastic polyesters, which comprises, as component A, a phosphinic acid salt of the formula (I) or (II)

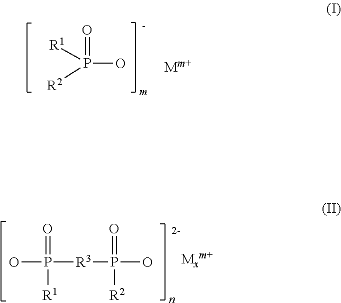

where R1 and R2 are identical or different and are H or C1-C6-alkyl, linear or branched, and/or aryl;
M is Mg, Ca, Al, Sb, Sn, Ge, Ti, Fe, Zr, Ce, Bi, Sr, Mn, Li, Na, K, and/or a protonated nitrogen base; preferably calcium ions, magnesium ions, aluminum ions, and/or zinc ions,
m is from 1 to 4; n is from 1 to 4; x is from 1 to 4, m preferably being 2 or 3; n preferably being 1 or 3 and x preferably being 1 or 2.

Examples of phosphinic acids which are suitable constituents of the phosphinic salts are:

Dimethylphosphinic acid, ethylmethylphosphinic acid, diethylphosphinic acid, methyl-n-propylphosphinic acid, methanedi(methylphosphinic acid), benzene-1,4-(dimethylphosphinic acid), methylphenylphosphinic acid, diphenylphosphinic acid.

According to the invention, the salts of the phosphinic acids may be prepared by known methods, for example those described in more detail in EP-A-699 708. Here, the phosphinic acids are reacted, by way of example, in aqueous solution with metal carbonates, metal hydroxides, or metal oxides.

The invention further comprises, as component B, phosphonate oligomers, polymers or copolymers. Linear and branched phosphonate oligomers and polymers are well known in the literature. For branched phosphonate oligomers or polymers see U.S. Pat. Nos. 2,716,101; 3,326,852; 4,328,174; 4,331,614; 4,374,971; 4,415,719; 5,216,113; 5,334,692; 4,374,971 3,442,854; 6,291,630 B1 and 6,861,499 B1. For phosphonate oligomers see U.S. Patent applications 20050020800A1, 20070219295A1 and 20080045673A1. References for linear phosphonate oligomers and polymers include U.S. Pat. Nos. 2,534,252; 3,946,093; 3,919,363; 6,288,210 B1; 2,682,522; 2,891,915 and 4,046,724.

The phosphonate copolymers may be random or block. Random polyesterphosphonates and random polycarbonatophosphonates can be prepared by several methods such as melt condensation from bisphenol, phosphonic acid ester monomers and carboxylic acid ester monomers or from bisphenol, phosphonic acid ester monomers and diphenyl carbonate monomers (See for example, DE-OS (German Published Specification) Nos. 2,925,206 and 2,925,208). The polymers made using these methods are random (or statistical) mixtures of the monomers. Random coplyhosphonates can also be prepared by extrusion of solutions of aromatic polyesters and aromatic polyphosphonates at elevated temperatures (U.S. Pat. No. 4,782,123). In U.S. Pat. No. 4,762,905 thermoplastic polyphosphonatocarbonates are prepared by polycondensation of at least one aromatic dihydroxy compound with a diaryl carbonate and a phosphonic acid diaryl ester in the presence of a basic polycondensation catalyst with heating under reduced pressure. In U.S. Pat. No. 4,508,890 thermoplastic polyphosphonatocarbonates are prepared by polycondensation of at least one aromatic dihydroxy compound with a diaryl carbonate and a phosphonic acid diaryl ester in the presence of a neutral catalyst. Preferred phosphonate copolymers are block copolymers, such as a poly(block-phosphonato-ester) or poly(block-phosphonato-cabonate). These are known and described in published US patent application 20070129511 A1. In some embodiments, at least one phosphonate oligomer or polyphosphonate and one or more polyester or polycarbonate may be linked to one another by a tranesterification or polycondensation reaction, and in certain embodiments, the poly(block-phosphonato-ester) and/or poly(block-phosphonato-cabonate) may exhibit a single glass transition temperature(Tg).

The phosphonate oligomers, polymers or copolymers, of embodiments of the invention, may have a relative solution viscosity (ηᵣₑₗ), measured in methylene dichloride, of from about 1.03 to greater than about 1.35. Relative viscosity is the ratio of the time it takes a specific volume of polymer solution to flow through a capillary tube and the corresponding time it takes for the pure solvent. Polyphosphonates not soluble in methylene dichloride are also appropriate.

The phosphonate oligomers or polymers prepared using bisphenol A may have a Tg of from about 28° C. to about 107′C. The copolymers can exhibit Tgs as high as 145° C. In some embodiments the phosphonate oligomer, polymer or copolymer may be branched or linear and may be prepared with up to about 50 mol % branching agent. In other embodiments, the phosphonate oligomer, polymer or copolymer may have a molecular weight (Mₙ) of from about 2,000 g/mol to about 35,000 g/mol, with a preferred Mₙ of from about 4000 to about 20,000 g/mole.

Phosphonic acid diaryl esters, alternatively called phosphodiesters, used for making oligomeric phosphonates and polyphosphonates may include those of formula (1):

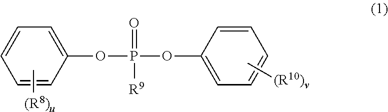

where each (R8)u and each (R10)v can independently be a hydrogen, lower alkyl of C1-C4, and u and v are independently integers where u=1 to 5, and v=1 to 5; R<9> can be lower alkyl C—C4. In embodiments, the phosphonic acid diaryl ester includes methyl-phosphonic acid diphenyl ester or methyldiphenoxyphosphine oxide where R<9> can be an alkyl radical or group, may be a methyl radical or group.

Phosphodiester, such as those of formula (1), used to prepare oligomeric phosphonate and/or polyphosphonates in embodiments of the invention may have a molar ratio: phosphodiester of structure 1 up to +−50 mol % related to bisphenol, in some embodiments up to +−20 mol %, and in other embodiments up to +−10 mol %.

Various dihydroxy aromatic compounds or bisphenols may be used alone or in combination with one another to form oligomeric phosphonates and/or polyphosphonates for use in embodiments of the invention. These dihydroxy aromatic compounds may be but are not limited to those of general formula (3):

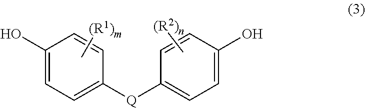

where each (R1)m and (R2)n can independently be a hydrogen, halogen atom, nitro group, cyano group, C1-C20 alkyl group, C4-C20 cycloalkyl group, or C6-C20 aryl containing group; m and n are independently integers 1 to 4; and Q may be a bond, oxygen atom, sulfur atom, or SO2 group for non-splitable bisphenols, and for splitable bisphenols Q may be the group

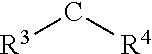

where R3 and R4 can independently be a hydrogen atom, lower alkyl Ci-C4 alkyl group, aryl, and substituted aryl. R3 and R4 may combine to form a C4-C20 cycloaliphatic ring which is optionally substituted by one or more C1-C20 alkyl groups, aryl groups, or a combination these.

One or more bisphenol may be used to prepare oligomeric phosphonates or polyphosphonates, and these bisphenols may include, but not be limited to bisphenol A, resorcinol, hydroquinone, and mixtures of these or mixtures including other bisphenols of formula (3) such as, but not limited to, 2,2-bis(4-hydroxy-3-methylphenyl)propane, 2,2-bis(3-chloro-4-hydroxyphenyl)propane, 2,2-bis(3-bromo-4-hydroxyphenyl)propane, 2,2-bis(4-hydroxy-3-isopropylphenyl)propane, I,I-bis(4-hydroxyphenyl)cyclohexane, I,I-bis(4-hydroxy-3-methylphenyl)cyclohexane, 4,4′-dihydroxydiphenyl, 4,4′-dihydroxydiphenylether, 4,4′-dihydroxydiphenylsulfide, 4,4′dihydroxydiphenylsulfone, 9,9-dihydroxy-diphenylfluorene, I,I-bis(4-hydroxyphenyl)-3,3-dimethyl-5-methylcyclohexane (TMC). Other bisphenols such as resorcinol and hydroquinone and mixtures of these with or without one or more bisphenol of structure (3) may also be useful in embodiments of the invention.

For example, the amount of bisphenol A, in embodiments of the invention, may range from about 100% to about 0.5% related to other bisphenols. In some embodiments, the phosphorous content of polymers of embodiments of the invention may be controlled by the molecular weight (Mw) of the bisphenol used in the oligomeric phosphonates or polyphosphonates. In particular, a lower molecular weight bisphenol will produce a higher the phosphorous content oligomeric phophonate or polyphosphonate. For example, bisphenols such as resorcinol, hydroquinone, or combinations of these or similar low molecular weight bisphenols may be used to make oligomeric phosphonates or polyphosphonates with high phosphorous content.

The phosphorus content, expressed in terms of the weight percentage, of the phosphonate oligomers or polymers may be in the range from 2% to 18%. For example, phosphonate oligomers or polymers prepared from bisphenol A or hydroquinone have phosphorus contents of 10.8 and 18%, respectively. The phosphonate copolymers have a smaller amount of phosphorus content compared to the phosphonate oligomers or polymers. For example, a copolymer containing phosphonate and carbonate components wherein the phosphonate component is comprised of the methyl diphenylphosphonate and bisphenol A at a concentration of 20% will have only about 2.16% phosphorus. A preferred range for phosphorus content in a phosphonate oligomer, polymer or copolymer is from about 2% to about 18%.

The transesterification catalyst may be any transesterification catalyst. In some embodiments, the tranesterification catalyst is a non-neutral transesterification catalyst, such as, for example, phosphonium tetraphenylphenolate, metal phenolate, sodium phenolate, sodium or other metal salts of bisphenol A, ammonium phenolate, non-halogen containing transesterification catalysts and the like, or transesterification catalysts such as those disclosed in PCT Pat. Application Serial Numbers PCT/US 2004005337 and PCTAJS 2004005443 filed Feb. 24, 2004 incorporated herein by reference in their entirety.

The inventive flame retardant mixture preferably comprises, as further component C, melamine condensates, such as melam, melem and/or melon.

The inventive flame retardant mixture preferably comprises, as further component C, benzoguanamine, tris(hydroxyethyl) isocyanurate, allantoin, glycoluril, melamine, melamine cyanurate, dicyandiamide and/or guanidine.

The inventive flame retardant mixture preferably comprises, as further component C, nitrogen compounds of the formulae (III) to (VIII), or a mixture thereof

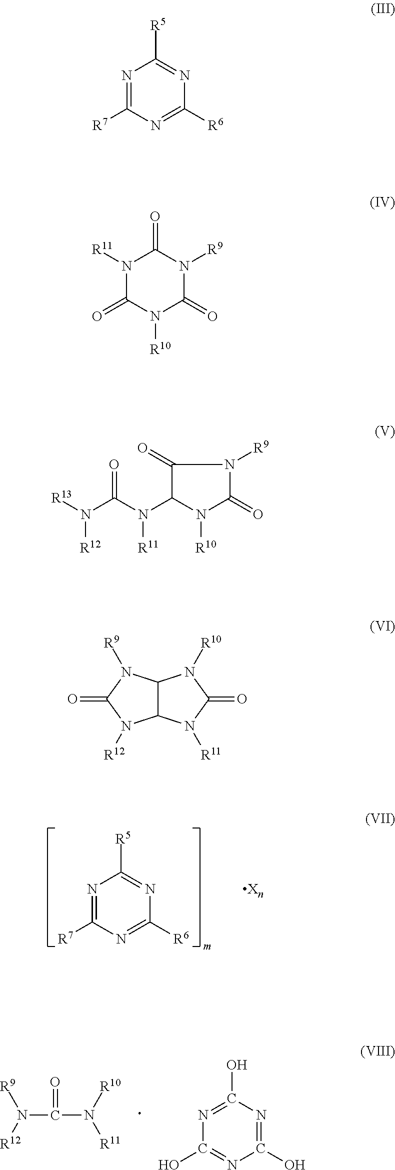

where R5 to R7 are hydrogen, C1-C8-alkyl, or C5-C16-cycloalkyl or -alkylcycloalkyl, unsubstituted or substituted with a hydroxy function or with a C1-C4-hydroxyalkyl function, or are C2-C8-alkenyl, C1-C8-alkoxy, -acyl, or -acyloxy, or C6-C12-aryl or -arylalkyl, or —OR8> or —N(R8)R9, including systems of alicyclic-N or aromatic-N type, R8> is hydrogen, C1-C8-alkyl, C5-C6-cycloalkyl or -alkylcycloalkyl, unsubstituted or substituted with a hydroxy function or with a C1-C4-hydroxyalkyl function, or is C2-C8-alkenyl, C1-C8-alkoxy, -acyl, or -acyloxy, or C6-C12-aryl or -arylalkyl,
R9 to R13 are the groups of R8, or else —O—R8,
m and n, independently of one another, are 1, 2, 3, or 4,
X is acids which can form adducts with triazine compounds (III).

The invention provides a plastics molding composition, comprising from 1 to 25% by weight of component A (phosphinic acid salt), from 1 to 25% by weight of component B (phosphonate oligomer, polymer or copolymer) and from 0 to 20% by weight of component C (melamine derivative), and also from 20 to 98% by weight of a thermoplastic polyester. Optionally, a reinforcing agent such as glass and an anti-dripping agent such as Teflon may be present. Also, conventional auxiliaries and additives may be present, the entirety of the components by weight giving 100% by weight.

Preference is given to a plastics molding composition, comprising from 3 to 20% by weight of component A, from 3 to 10% by weight of component B, from 0 to 10% by weight of component C, and also from 53 to 94% by weight of polyester. Optionally glass fiber in the range of about 5 to about 40% by weight is preferred. Also, if appropriate, conventional auxiliaries and additives, the entirety of the components by adding up to give a total composition of 100% by weight

Particular preference is given to a plastics molding composition, comprising from 5 to 15% by weight of component A, from 5 to 10% by weight of component B, from 0 to 5% by weight of component C, and also from 60 to 90% by weight of polyester, and optionally glass fibers in the range from about 15 to about 30% by weight, and also, if appropriate, conventional auxiliaries and additives, the entirety of the components adding up to give a total composition of 100% by weight.

The invention also provides the use of the inventive flame retardant mixture for providing flame retardancy to polyesters. Polyesters are polymers whose polymer chain has repeat units bonded by way of an ester group. Polyesters which may be used according to the invention are described by way of example in “Ullmanns encyclopedia of industrial chemistry”, ed. Barara Elvers, Vol. A21, Chapter “Polyesters” (pp. 227-251), VCH, Weinheim-Basel-Cambridge-New York 1992, expressly incorporated herein by way of reference. Copolyesters are also suitable.

It is contemplated that the flame retardant compositions of the present invention may comprise other components, such as fillers, lubricants, surfactants, organic binders, polymeric binders, crosslinking agents, coupling agents, anti-dripping agents such as Teflon, heat and light stabilizers, antistatic agents, antioxidants, nucleating agents, carbodiimides colorants, inks, dyes, or any combination thereof. EP-A-0 584 567 gives examples for the additives which may be used.

The flame retardant compositions of the present invention can be used as coatings or they can be used to fabricate articles, such as free-standing films, fibers, foams, molded articles and fiber reinforced composites. In the case of fiber reinforced composites, the reinforcement may be in the form of continuous, woven, or chopped fibers including glass, carbon, inorganic fibers such as silicon carbide and organic fibers or combinations thereof. These articles may be well-suited for applications requiring fire resistance.

Polyesters which comprise the inventive flame retardant mixture and, if appropriate, comprise fillers and reinforcing materials and/or other additives, as defined below, are hereinafter termed plastics molding compositions.

The polymers of the flame-retardant plastics molding composition preferably comprise thermoplastic polyesters and more preferably are poly(butylene terephthalate) (PBT), poly(trimethylene terephthalate) (PTT) or poly(ethylene terephthalate) (PET).

The amount of the phosphinic acid salt (component A) to be added to the polymers may vary within wide limits. The amount used is generally from 0.1 to 30% by weight, based on the plastics molding composition. The ideal amount depends on the nature of the polymer and on the type of components B and C, and on the character of the actual phosphinic salt used. Preferred amounts are from 0.5 to 25% by weight, in particular from 1 to 20% by weight, based on the plastics molding composition.

The physical form in which the abovementioned phosphinic salts are used for the inventive flame retardant and stabilizer combined can vary, depending on the type of polymer used and on the properties desired. By way of example, the phosphinic salts can be milled to give a fine-particle form to achieve better dispersion within the polymer. Mixtures of various phosphinic salts may also be used, if desired.

The amount of the phosphonate oligomer, polyphosphonate or copolyrphosphonate (component B) to be added to the polymers may vary within wide limits. The amount used is generally from 0.1 to 20% by weight, based on the plastics molding composition. The ideal amount depends on the nature of the polymer, on the type of phosphinic salt (component A) used, and on the type of nitrogen compound (component C) used. Amounts of from 0.5 to 15% by weight, in particular from 1 to 10% by weight, are preferred.

The amount of the nitrogen compound (component C) to be added to the polymers may vary within wide limits. The amount used is generally from 0.1 to 20% by weight, based on the plastics molding composition. The ideal amount depends on the nature of the polymer and on the type of phosphinic salt (component A) used, on the type phosphonate oligomer, polyphosphonate or copolyphosphonate (component B) used, and on the type of nitrogen compound used.

There are many possible ways to mix the components, and the order of addition of each component can be in any sequence compatible with the desired mixing process. An example of a method for incorporating components A, B, and C into a thermoplastic polyester premixes all of the constituents in the first step in the form of powder and/or pellets in a mixer, and then in the second step, the material is homogenized in the polymer melt in a compounding assembly (e.g. a twin-screw extruder). Optionally additional materials such as glass fibers are also added and mixed in the first step. The melt is usually drawn off in the form of an extrudate, cooled, and pelletized. Another example of mixing components A, B, and C and, optionally glass fibers and/or additional additives may also be introduced by way of a metering system directly into the compounding assembly in any desired order of sequence. It is preferred to add component B (phosphonate oligomer, polymer or copolymer), and if desired glass fibers, near the end of the extrusion process.

It is also possible for the flame-retardant additives A, B, and C, and optionally glass fibers and/or additional additives to be admixed with ready-to-use polymer pellet or ready-to-use polymer powder, and for the mixture to be directly processed in an injection molding machine to give moldings.

By way of example, in the case of polyesters the flame-retardant additives A, B, and C, and optionally glass fibers and/or additional additives may also be added to the polyester composition during the polycondensation process.

As described, in addition to the inventive flame retardant mixture composed of A, B, and C, it is also possible for fillers and reinforcing material, such as glass fibers, glass beads, or minerals, such as chalk, to be added to the molding compositions.

### EXAMPLES

1. Components Used

Commercially available polymers (pellets):

Polybutylene terephthalate (PBT): Ultradure B 4500 (BASF AG, D).

Component A: Aluminum diethylphosphinate, hereinafter termed DEPAL.

Component B: Polyphosphonate, hereinafter termed FRX-100 was prepared according to the following procedure.

Synthesis of Polyphosphonate

Into 6 L reactor equipped with a distillation column and mechanical stirrer was placed the 2,2-bis-(4-hydroxyphenyl) propane (bisphenol A, 1.308 kg, 5.737 mol), 120 mg Sodium phenolate (NaOPh) catalyst, 1467 g (5.915 mol) methylphosphonic acid diphenyl ester and 225 mg tetraphenylphosphonlum phenolate. The mixture was heated from 250 to 300° C. while reducing the pressure from 150 to 0.4 mm Hg over about 8-9 hours period. Approximately 1374 g of distillate was collected over the course of the reaction. A noticeable, rapid increase in solution viscosity of the melt was observed over the last hour of the reaction. At the end, the torque (as measurement of melt viscosity and therefore molecular weight) of 12.5±0.4 at 300° C. with a stirrer speed of 110 rpm.

The polymer was extruded out of reactor into a water bath to form a strand and subsequently pelletized. The polymer was transparent, colorless and tough. It exhibited a Tg of 102° C. The product was not fully soluble in methylene chloride after 12 hours. The percentage of phosphorous in this polymer was 10.8% by weight. The molecular weight was measured by gel permeation chromatography using a refractive index detector. Based on a polystyrene standard, the polyphosphonate exhibited a Mn of 9379, a Mw of 43480 and a polydispersity of 4.6.

Component C: Melapur® MC (melamine cyanurate), Ciba Specialty Chemicals, CH

Other Additives:

Vetrotex EC 10 P 952 (glass fibers)

2. Preparation, Processing, and Testing of Flame-Retardant Plastics Molding Compositions

The flame retardant components and stabilizer components were mixed in the ratio stated in the tables with the polymer pellets and optionally with additives, and incorporated at temperatures of from 240 to 280° C. in a twin-screw extruder (Leistritz ZSE 27 HP-44D). The homogenized polymer strand was drawn off, cooled in a water bath, and then pelletized.

After adequate drying, the molding compositions were processed in an injection molding machine (Arburg Allrounder 320° C.) at melt temperatures of from 260 to 280° C., to provide test specimen. Afterwards these specimen were tested and classified for flame retardancy according to the UL 94 vertical test (Underwriters Laboratories).

The Limit Oxygen Index (LOI) was measured as described in the American Standard Method (ASTM) D 2863. The higher the LOI value the more resistant a material will usually be to ignition and combustion.

Solution viscosity (SV) was used to assess the processing properties of the inventive combinations in polyester. Pellets of the plastics molding composition were used, after adequate drying, to prepare a 1.0% strength solution in dichloroacetic acid, and the SV value was determined as a dimensionless number. The higher the SV, the smaller the degree of polymer degradation during incorporation of the flame retardant.

The “glow wire ignition temperature” (GWIT) was determined following the procedure described in IEC 60695-2-13. The higher the GWIT value the less ignitable a material will usually be under the conditions of a failure (e.g. short circuit) in an electrical device.

The “comparative tracking index” (CTI) was measured according to IEC 60112. The CTI value represents the voltage at which no tracking occurs between two electrodes on the surface of the tested plastic material, after 50 drops of an ammonium chloride solution were applied. The higher the CTI value the better the resistance of the insulating material to tracking for voltages up to 600 V, when the surface is exposed under electric stress to water containing conductive impurities.

3. Test Results

Table 1 shows examples of the inventive combinations in PBT and the test results obtained in columns 5-8. Examples 1-4 are comparative examples in which neat PBT was tested as well as the aluminum diethylphosphinate DEPAL (component A), polyphosphonate FRX-100 (component B) and melamine cyanurate (component C) were tested in PBT, as sole flame retardant components.

| Example # | 1 | 2 | 3 | 4 | 5 | 6 | 7 | 8 |
|---|---|---|---|---|---|---|---|---|
| PBT | 70 | 50 | 50 | 50 | 50 | 50 | 50 | 40 |
| Glass fibers | 30 | 30 | 30 | 30 | 30 | 30 | 30 | 30 |
| DEPAL | | 20 | | | 15 | 10 | 5 | 15 |
| FRX-100 | | | 20 | | 5 | 10 | 15 | 5 |
| MC | | | | 20 | | | | 10 |
| UL 94 class | n.c. | V-0 | n.c. | n.c. | V-0 | V-2 | V-2 | V-0 |
| LOI | 20 | 43 | 25 | 23.5 | 39 | 31 | 26 | 40 |
| SV | 1405 | 1050 | 1799 | 1398 | 1328 | 1422 | 1544 | 1300 |
| GWIT, ° C. | 700 | 750 | 800 | 725 | 775 | 775 | 775 | 800 |
| CTI, V | 550 | 550 | 375 | 400 | 500 | 450 | 450 | 550 |

n.c. = non classifiable

The results of the inventive examples 5-8, in which the flame retardant mixtures of the present invention are used show that UL classes V-0 or V-2 and high LOI values are achieved by these combinations. Moreover, a high level of solution viscosity and of GWIT was measured. The combination of these desirable results cannot be achieved by either one of the single flame retardants on its own. The level of CTI measured for the inventive combinations is still higher than that with reinforced PBT flame retarded with either neat FRX-100 or neat melamine cyanurate.

We claim:

1. A plastic molding composition comprising at least one of each of the following constituents: 1) a thermoplastic polyester, 2) a phosphinate salt, 3) melamine, a melamine derivative, or melamine salt and 4) a phosphonate component comprised of an oligomeric phosphonate, polyphosphonate or copolyphosphonate.

2. The composition of claim 1, wherein the phosphonate component has a phosphorus content of at least 2% by weight.

3. The composition of claim 1, wherein the thermoplastic polyester is polybutylene terephthalate, the phosphinate salt is aluminum diethylphosphinate, the melamine derivative is melamine cyanurate, and the phosphonate component is a branched polyphosphonate prepared from diphenylmethylphosphonate, 2,2-bis(4-hydroxyphenyl)propane, and 1,1,1-tris(4-hydroxyphenyl)ethane.

4. The composition of claim 1, further comprising at least one additional component selected from the group consisting of glass fiber, carbon fiber, inorganic fiber, organic fiber, fillers, surfactants, organic binders, polymeric binders, crosslinking agents, coupling agents, anti-dripping agents, colorants, inks, dyes, antioxidants and a combination thereof.

5. The composition of claim 4, wherein the at least one additional component is comprised of glass fibers.

6. The composition of claim 5, wherein the composition exhibits a glow wire ignition temperature of at least 775° C.

7. An article of manufacture comprising from the composition of claim 5.

8. An article of manufacture according to claim 7, wherein the article is a fiber, a film, a coating, a molding, a foam, a fiber reinforced article, or any combination thereof.

9. The composition of claim 1, wherein the composition exhibits a glow wire ignition temperature of at least 775° C.

10. An article of manufacture comprising from the composition of claim 1.

11. An article of manufacture according to claim 10, wherein the article is a fiber, a film, a coating, a molding, a foam, a fiber reinforced article, or any combination thereof.

12. The plastic molding composition of claim 1, wherein the at least phoshinate salt is a phosphinic acid salt of the formula (I) or (II) 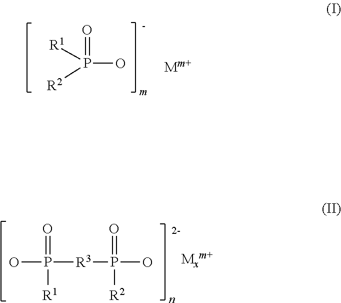
wherein R1 and R2 are identical or different and are H or C1-C6-alkyl, linear or branched or aryl;
M is Mg, Ca, Al, Sb, Sn, Ge, Ti, Fe, Zr, Ce, Bi, Sr, Mn, Li, Na, K, a protonated nitrogen base or a mixture thereof;
m is from 1 to 4; n is from 1 to 4; x is from 1 to 4.

13. The plastics molding composition as claimed in claim 12, wherein M is calcium ions, magnesium ions, aluminum ions, zinc ions or a mixture thereof.

14. The plastics molding composition as claimed in claim 12, wherein m is 2 or 3; n is 1 or 3 and x is 1 or 2.
